(19) United States
(12) Patent Application Publication
(10) Pub. No.: US 2020/0266507 A1
(43) Pub. Date: Aug. 20, 2020

(54) BATTERY MODULE AND SYSTEM

(71) Applicant: 3M INNOVATIVE PROPERTIES COMPANY, St. Paul, MN (US)

(72) Inventors: Bernhard Brunnsteiner, Graz (AT); Harald Stuetz, Semriach (AT); Daniele Suzzi, Gutenberg-Stenzengreith (AT); Enes Aksamija, Graz (AT); Veronika Obersteiner, Graz (AT)

(21) Appl. No.: 16/792,920

(22) Filed: Feb. 18, 2020

Related U.S. Application Data
(60) Provisional application No. 62/806,953, filed on Feb. 18, 2019.

(51) Int. Cl. H01M 10/6556; H01M 2/10; H01M 10/6552; H01M 10/647

(52) U.S. Cl. CPC H01M 10/6556; H01M 10/647; H01M 10/6552; H01M 2/1077

(57) ABSTRACT

A battery module includes a housing defining a longitudinal direction along a length of the housing. The battery module also includes a plurality of electrochemical cells received within the housing. The battery module further includes a first inlet configured to receive a first flow of fluid. The battery module includes at least one first flow channel in fluid communication with the first inlet and extending along the longitudinal direction of the housing. The battery module includes a first outlet in fluid communication with the at least one first flow channel. The battery module further includes a second inlet configured to receive a second flow of fluid. The battery module includes at least one second flow channel in fluid communication with the second inlet and extending along the longitudinal direction of the housing. The battery module includes a second outlet in fluid communication with the at least one second flow channel.

### TECHNICAL FIELD

The present disclosure relates generally to improvements in or relating to battery modules and is more particularly concerned with thermal management of battery modules and systems.

### BACKGROUND

Battery packs are used in various applications (e.g., automotive applications) to power one or more components. Managing heat generated during a use of the battery packs is important for optimizing battery performance and driving range in automotive applications. It is desirable to maintain the battery packs within safe operating temperature ranges, and therefore there is a need to cool the battery packs efficiently.

Battery packs typically include a thermal management system in which a thermal management fluid exchanges heat with components of the battery packs to maintain the components within the safe operating temperature ranges. For example, the thermal management system may include a direct contact cooling system, also known an immersion cooling system, wherein the components of the battery pack are directly immersed in a vat of dielectric liquid. However, this type of direct cooling systems are limited in application to battery packs using small format cylindrical cells. Thus, it is a challenge to use dielectric liquids as a thermal management fluid for battery packs having large format cells, such as prismatic cells.

### SUMMARY

In one aspect, the present disclosure provides a battery module. The battery module includes a housing defining a longitudinal direction along a length of the housing. The battery module also includes a plurality of electrochemical cells received within the housing. The battery module further includes a first inlet configured to receive a first flow of fluid. The battery module includes at least one first flow channel in fluid communication with the first inlet, extending along the longitudinal direction of the housing, and configured such that a fluid flowing in the at least one first flow channel contacts the plurality of electrochemical cells. The battery module also includes a first outlet in fluid communication with the at least one first flow channel. The battery module further includes a second inlet configured to receive a second flow of fluid. The battery module includes at least one second flow channel in fluid communication with the second inlet, extending along the longitudinal direction of the housing, and configured such that a fluid flowing in the at least one second flow channel contacts the plurality of electrochemical cells. The battery module also includes a second outlet in fluid communication with the at least one second flow channel.

The present disclosure may allow usage of dielectric fluid as a thermal management fluid for large format cells, such as prismatic cells and pouch cells. Further, the first and second flow channels may include a smaller diameter which in turn provides high flow rates inside such channels. A thermal management arrangement for the battery module may provide efficient cooling of the components of the battery module with lesser amount of fluid and may require a low amount of pumping power for fluid circulation. The battery module of the present disclosure may eliminate requirement of side flow channels thereby reducing an overall length of the battery module and providing a higher battery energy density. Additionally, the elimination of the side flow channels may also allow usage of end plates without side flow channels that are available at lower costs.

In another aspect, the present disclosure provides a battery system. The battery system includes a plurality of battery modules electrically connected to each other. Each of the plurality of battery modules includes a housing defining a longitudinal direction along a length of the housing. Each of the plurality of battery modules also includes a plurality of electrochemical cells received within the housing. Each of the plurality of battery modules further includes a first inlet configured to receive a first flow of fluid. Each of the plurality of battery modules includes at least one first flow channel in fluid communication with the first inlet, extending along the longitudinal direction of the housing, and configured such that a fluid flowing in the at least one first flow channel contacts the plurality of electrochemical cells. Each of the plurality of battery modules also includes a first outlet in fluid communication with the at least one first flow channel. Each of the plurality of battery modules further includes a second inlet configured to receive a second flow of fluid. Each of the plurality of battery modules includes at least one second flow channel in fluid communication with the second inlet, extending along the longitudinal direction of the housing, and configured such that a fluid flowing in the at least one second flow channel contacts the plurality of electrochemical cells. Each of the plurality of battery modules also includes a second outlet in fluid communication with the at least one second flow channel.

The battery system mentioned above provides improved design flexibility for connection of the plurality of battery modules within the battery system. For example, a number of battery modules and the arrangement (e.g., series and/or parallel) of the battery modules may be varied as per application requirements. The present disclosure may allow usage of dielectric fluid as a thermal management fluid for large format cells, such as prismatic cells and pouch cells. Further, the first and second flow channels may include a smaller diameter which in turn provides high flow rates inside such channels. A thermal management arrangement for the battery module may provide efficient cooling of the components of the battery module with lesser amount of fluid and may require a low amount of pumping power for fluid circulation. The battery module of the present disclosure may eliminate requirement of side flow channels thereby reducing an overall length of the battery module and providing a higher battery energy density. Additionally, the elimination of the side flow channels may also allow usage of end plates without side flow channels that are available at lower costs.

In another aspect, the present disclosure provides a battery module. The battery module includes a housing defining a longitudinal direction along a length of the housing. The housing includes a first longitudinal end and a second longitudinal end opposite to the first longitudinal end. The battery module also includes a plurality of electrochemical cells received within the housing. The battery module further includes a first inlet configured to receive a first flow of fluid. The battery module includes at least one first flow channel in fluid communication with the first inlet, extending along the longitudinal direction of the housing, and configured such that a fluid flowing in the at least one first flow channel contacts the plurality of electrochemical cells. The battery module also includes a first outlet in fluid communication with the at least one first flow channel. The battery module further includes a second inlet configured to receive a second flow of fluid. The battery module includes at least one second flow channel in fluid communication with the second inlet, extending along the longitudinal direction of the housing, and configured such that a fluid flowing in the at least one second flow channel contacts the plurality of electrochemical cells. The battery module also includes a second outlet in fluid communication with the at least one second flow channel. Further, the first inlet and the second outlet are disposed at the first longitudinal end, and the second inlet and the first outlet are disposed at the second longitudinal end.

The present disclosure may allow usage of dielectric fluid as a thermal management fluid for large format cells, such as prismatic cells and pouch cells. Further, the first and second flow channels may include a smaller diameter which in turn provides high flow rates inside such channels. Each of the first and second flow of fluids flow in opposite directions and may have different temperature distributions and flow rates, which provides improved fluid distribution across the battery module and effective cooling of the electrochemical cells. A thermal management arrangement for the battery module may provide efficient cooling of the components of the battery module with lesser amount of fluid and requires a low amount of pumping power for fluid circulation. The battery module of the present disclosure may eliminate requirement of side flow channels thereby reducing an overall length of the battery module and providing a higher battery energy density. Additionally, the elimination of the side flow channels may also allow usage of end plates without side flow channels that are available at lower costs.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a block diagram illustrating a battery system having a plurality of battery modules according to one embodiment of the present disclosure;

FIG. 2 is a perspective view of a single battery module according to one embodiment of the present disclosure;

FIG. 3 is a perspective view of the battery module illustrating a plurality of electrochemical cells according to one embodiment of the present disclosure;

FIG. 4 is a sectional view of the battery module according to one embodiment of the present disclosure; and

FIG. 5 is a block diagram illustrating various components associated with the battery module according to one embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

The present disclosure will be described with respect to particular embodiments and with reference to certain drawings, but the disclosure is not limited thereto. The drawings described are only schematic and are non-limiting. In the drawings, the size of some of the elements may for illustrative purposes be exaggerated and not drawn to scale.

It will be understood that the terms “vertical”, “horizontal”, “top”, “bottom”, “above”, “below”, “left”, “right” etc. as used herein refer to particular orientations of the figures and these terms are not limitations to the specific embodiments described herein.

Typically, battery systems include a plurality of battery modules that may be electrically connected in series arrangement and/or parallel arrangement. The battery modules include electrochemical cells disposed therein. Such battery modules may require a thermal management arrangement to maintain an operating temperature of the electrochemical cells within a predefined limit. The thermal management arrangement allows flow of a thermal management fluid, such as a dielectric fluid, through the battery module for maintaining the operating temperature of the electrochemical cells. However, as described above, conventional thermal management arrangements may not provide effective cooling for large format cells, such as prismatic cells and pouch cells. The arrangement of two inlets, two outlets, and two separate flows in a battery module of the present disclosure may enable effective thermal management for large format cells.

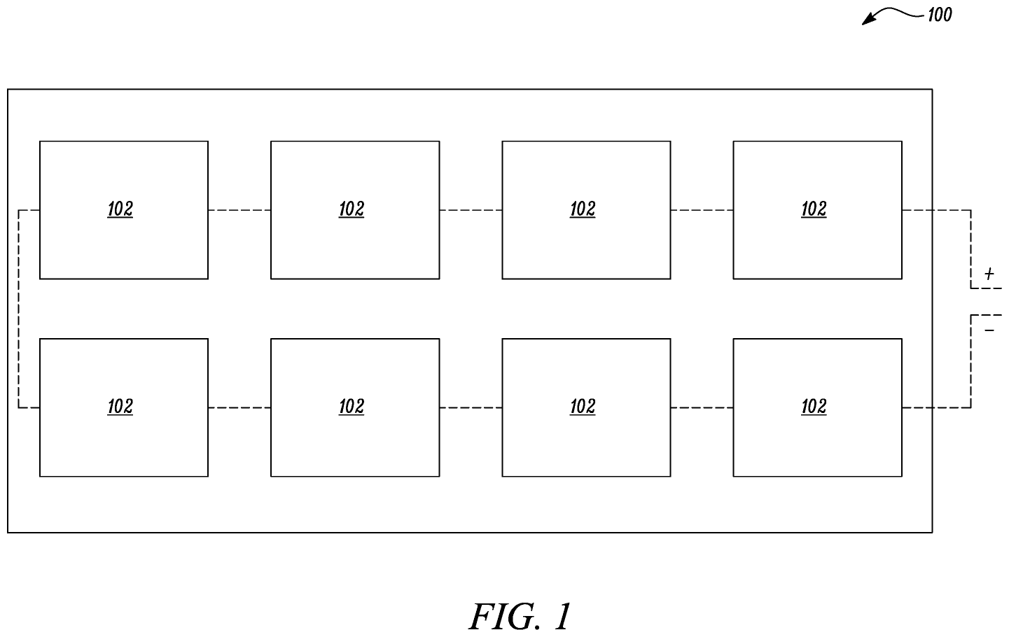

FIG. 1 illustrates a block diagram of a battery system 100. The battery system 100 may be used in various applications, such as automotive applications, data centers and stationary energy storage systems. The battery system 100 includes a plurality of battery modules 102 electrically connected to each other. In the illustrated embodiments, the battery modules 102 are connected in a combined series and parallel arrangement. In another example, the plurality of battery modules 102 may be connected in a series arrangement. Alternatively, the plurality of battery modules 102 may be connected in a parallel arrangement. A number and an arrangement of the battery modules 102 may be varied as per application requirements. For explanatory purposes, a single battery module 102 will be explained in detail in the description provided below. However, it should be noted that the description provided below is applicable to all the battery modules 102 of the battery system 100.

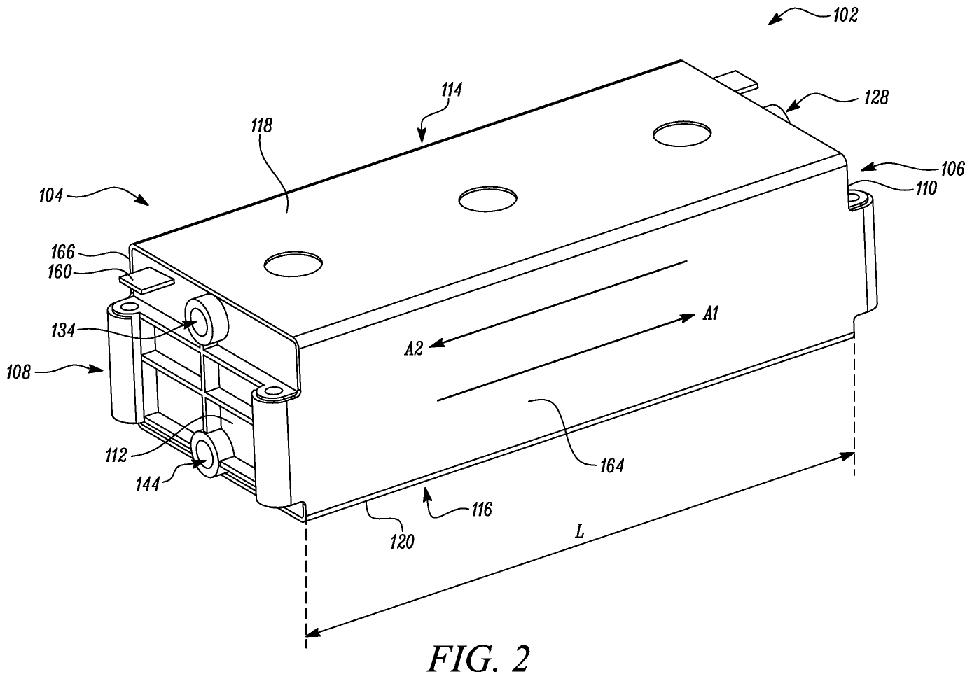

Referring now to FIG. 2, a perspective view of the battery module 102 is illustrated. The battery module 102 includes a housing 104 defining a longitudinal direction “A1” along a length “L” of the housing 104. The longitudinal direction “A1” is defined along the length “L” of the housing 104. In the illustrated example, the housing 104 is generally rectangular in shape, however, the housing 104 may include any other shape. The housing 104 includes a first longitudinal end 106 and a second longitudinal end 108 opposite to the first longitudinal end 106.

A first end plate 110 of the housing 104 is defined at the first longitudinal end 106 and a second end plate 112 of the housing 104 is defined at the second longitudinal end 108. Further, the housing 104 includes an upper end 114 and a lower end 116 opposite to the upper end 114. The housing 104 includes an upper plate 118 and a lower plate 120. The upper plate 118 is defined at the upper end 114 whereas the lower plate 120 is defined at the lower end 116. Additionally, the housing 104 defines a front plate 164 and a rear plate 166, such that the first and second end plates 110, 112, the upper plate 118, the lower plate 120, and the front and rear plates 164, 166 together define a hollow portion (not shown) within the housing 104. Further, the battery module 102 includes an inner cover 162 provided proximal to the upper end 114 of the housing 104.

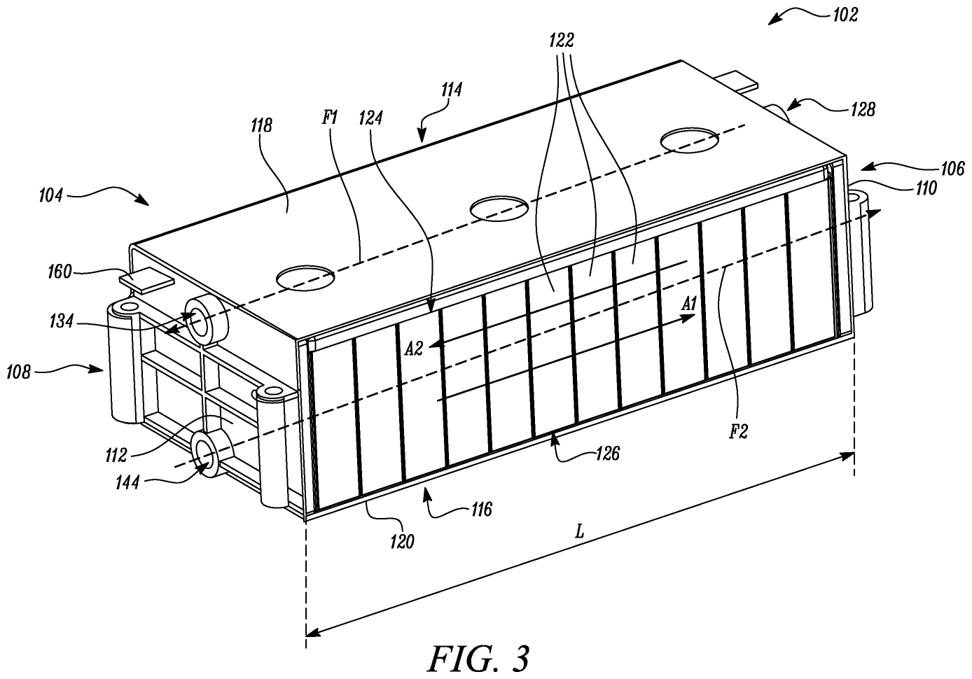

As shown in FIG. 3, the battery module 102 also includes one or more busbars 160, a portion of which is shown herein, provided for power distribution. The battery module 102 also includes a plurality of electrochemical cells 122 received within the housing 104. The electrochemical cells 122 may be electrically connected in series and/or parallel. More particularly, the electrochemical cells 122 are received within the hollow portion of the housing 104. The plurality of electrochemical cells 122 mentioned herein are embodied as energy storage devices. It should be noted that the battery module 102 may include any other type of energy storage devices apart from the electrochemical cells 122. In the illustrated example, each of the plurality of electrochemical cells 122 is a prismatic cell. However, the electrochemical cells 122 may include another type of cell, without limiting the scope of the present disclosure. The plurality of electrochemical cells 122 are disposed adjacent to each other along the longitudinal direction “A1” of the housing 104. Each of the plurality of electrochemical cells 122 includes a top surface 124 and a bottom surface 126 opposite to the top surface 124.

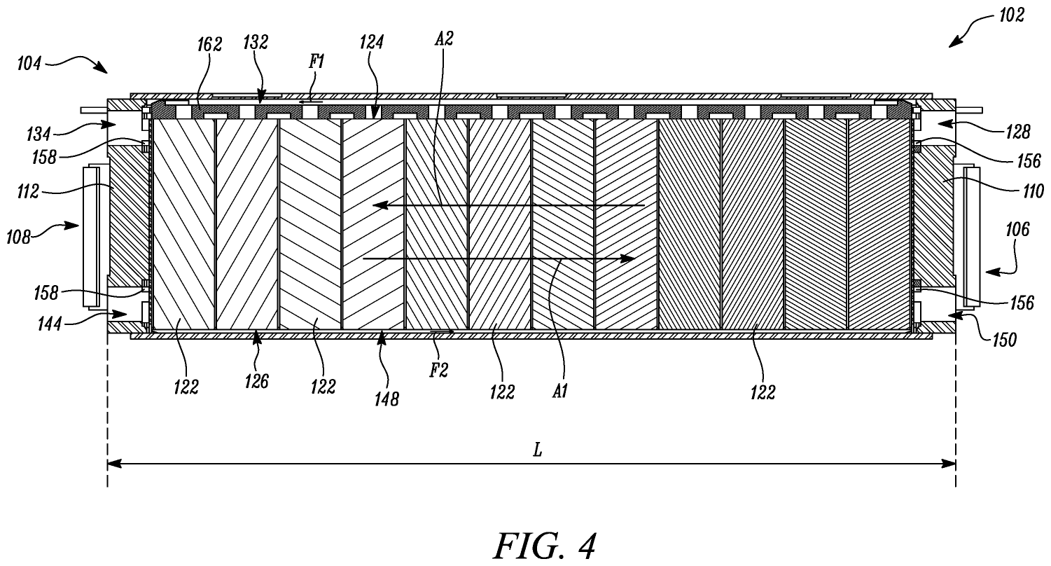

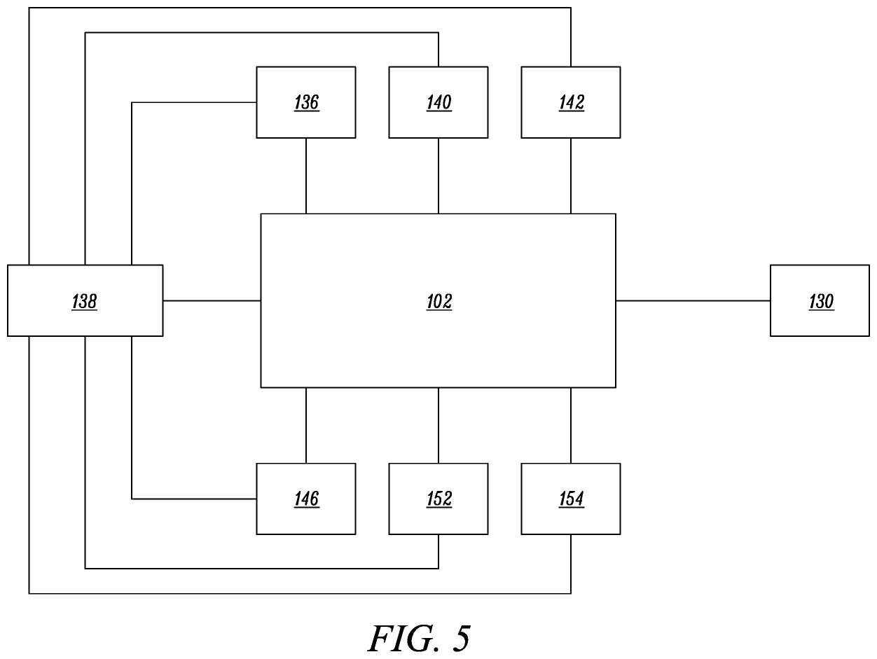

During an operation of the battery module 102, a temperature of the electrochemical cells 122 should be maintained within a desired operating range. Thus, a thermal management (e.g., cooling or heating) arrangement is associated with the battery module 102 to maintain or adjust the temperature of the of the electrochemical cells. In one embodiment, the battery module 102 is at least partially immersed in a fluid thermal management purposes. Alternatively, the battery module 102 may be fully immersed in the fluid. The fluid is a thermal management fluid. In one example, the fluid is a cooling liquid. The fluid includes a halogenated compound or an oil. Further, the housing 104 defines each of a first inlet 128, a first outlet 134, a second inlet 144, and a second outlet 150 (shown in FIG. 4). More particularly, the battery module 102 includes the first inlet 128 configured to receive a first flow of fluid “F1”. The first inlet 128 is in fluid communication with a reservoir 130 (see FIG. 5) that stores the fluid therein. The first inlet 128 receives the first flow of fluid “F1” from the reservoir 130. Further, a pump (not shown) may be associated with the reservoir 130 that pressurizes the fluid so that the fluid may flow through the battery module 102. In the illustrated example, the first flow of fluid “F1” flows in a direction “A2” that is opposite to the longitudinal direction “A1”. As illustrated, the second end plate 112 of the housing 104 defines the first inlet 128. More particularly, the first inlet 128 is disposed at the first longitudinal end 106. Further, the first inlet 128 is disposed proximal to the upper end 114.

As shown in FIG. 4, the battery module 102 includes a pair of first flow blockers 156 provided at the first longitudinal end 106 of the housing 104. The pair of first flow blockers 156 may be embodied as structural members configured to isolate the first flow of fluid “F1” and a second flow of fluid “F2”. The pair of first flow blockers 156 may be disposed within the first end plate 110. Further, the battery module 102 includes a pair of second flow blockers 158 provided at the second longitudinal end 108 of the housing 104. The pair of second flow blockers 158 may be embodied as structural members configured to isolate the first flow of fluid “F1” and the second flow of fluid “F2”. The pair of second flow blockers 158 may be disposed within the second end plate 112.

The battery module 102 includes at least one first flow channel 132 and at least one second flow channel 148. Each of the first flow channel 132 and the second flow channel 148 is defined by the housing 104 and the electrochemical cells 122. In some embodiments, the first flow channel 132 is defined within the inner cover 162 of the battery module 102. Alternatively, the first flow channel 132 may be defined between the top surfaces 124 of the electrochemical cells 122 and the upper plate 118 of the housing 104. The first flow channel 132 is in fluid communication with the first inlet 128, extending along the longitudinal direction “A1” of the housing 104, and configured such that a fluid flowing in the at least one first flow channel 132 contacts the plurality of electrochemical cells 122. For exemplary purposes, only a single first flow channel 132 is illustrated herein. However, it should be noted that the battery module 102 may include multiple first flow channels 132 such that each of the multiple first flow channels 132 is in communication with the first inlet 128 and the first outlet 134. The first flow channel 132 may have any suitable cross-section, such as rectangular, circular, and so forth.

The first flow channel 132 is disposed proximal to the upper end 114 of the housing 104. Further, the first flow channel 132 is disposed adjacent to the top surface 124 of each of the plurality of electrochemical cells 122. The fluid flowing in the first flow channel 132 contacts the plurality of electrochemical cells 122. The first flow channel 132 receives the first flow of fluid “F1” from the first inlet 128. While flowing through the first flow channel 132, the first flow of fluid “F1” produces a temperature gradient for the electrochemical cells 122 as thermal energy is transferred. More particularly, the first flow of fluid “F1” flowing through the first flow channel 132 exchanges heat with the electrochemical cells 122 in order to maintain a temperature of the electrochemical cells 122 close to a desired operating temperature.

It should be noted that in some cases it may be desirable to heat the electrochemical cells 122, such as for start-up in low temperature ambient scenarios. In such cases, relative temperatures may be reversed to transfer thermal energy to the electrochemical cells 122 from the first flow of fluid “F1”. Further, the first flow channel 132 may have a smaller diameter as the fluid that flows through the first flow channel 132 exhibits low viscosity and low surface tension that provides high flow rates inside such channels.

Referring now to FIG. 5, the battery module 102 includes a first valve 136. The first valve 136 controls the first flow of fluid “F1” flowing through the first flow channel 132. In an activated position, the first valve 136 provides fluid communication between the reservoir 130 and the first inlet 128. The first valve 136 may be activated or deactivated based on control signals received from a control module 138 associated with the battery module 102. The control module 138 may embody a single microprocessor or multiple microprocessors for receiving signals from components of the battery module 104. Numerous commercially available microprocessors may be configured to perform the functions of the control module 138. The control module 138 may further include a memory (not shown) to store data and algorithms therein. Further, the battery module 102 includes a first temperature sensor 140 and a first flow rate measuring sensor 142. The first temperature sensor 140 is used to measure a temperature of the first flow of fluid “F1” that flows through the first flow channel 132. Further, the first flow rate measuring sensor 142 is used to measure a flow rate of the first flow of fluid “F1” through the first flow channel 132. In an example, one or more of the busbars 160 may be used for connection lines corresponding to the first temperature sensor 140 and the first flow rate measuring sensor 142 for measuring temperature and flow rate values.

The control module 138 receives signals corresponding to the temperature of the first flow of fluid “F1” and the flow rate of the first flow of fluid “F1”. Further, the control module 138 compares the received signals with corresponding predetermined threshold values corresponding to temperature and flow rate of the first flow of fluid “F1” that may be stored in the memory of the control module 138. Based on the comparison, the control module 138 generates output signals for controlling the temperature of the first flow of fluid “F1” and the flow rate of the first flow of fluid “F1” so that the temperature of the electrochemical cells 122 may be maintained at or adjusted to a desired operating temperature range. For example, the control module 138 may generate an output signal pertaining to an increase or decrease in the temperature of the first flow of fluid “F1”. Accordingly, the first flow of fluid “F1” may be treated such that the temperature of the first flow of fluid “F1” corresponds to the predetermined threshold value for the temperature. In an example, a heat exchanging device may be positioned downstream of the reservoir 130 so that the temperature of the first flow of fluid “F1” may be controlled. Further, the control module 138 may generate an output signal pertaining to an increase or decrease in the flow rate of the first flow of fluid “F1”. Accordingly, the flow rate of the first flow of fluid “F1” may be adjusted such that the flow rate of the first flow of fluid “F1” corresponds to the predetermined threshold value for the flow rate. In an example, the control module 138 may control the pump, or the first valve 136 may be embodied as a variable flow valve that may be controlled by the control module 138 for adjusting the flow rate of the first flow of fluid “F1”.

Referring now to FIG. 4, the battery module 102 further includes the first outlet 134. The first outlet 134 is in fluid communication with the first flow channel 132. As illustrated, the first end plate 110 of the housing 104 defines the first outlet 134. More particularly, the first outlet 134 is disposed at the second longitudinal end 108. Further, the first outlet 134 is disposed proximal to the upper end 114. The first flow channel 132 provides fluid communication between the first inlet 128 and the first outlet 134. Further, the first outlet 134 is in fluid communication with the reservoir 130 such that the first flow of fluid “F1” that exits the battery module 102 via the first outlet 134 is recirculated back to the reservoir 130.

The battery module 102 includes the second inlet 144 configured to receive the second flow of fluid “F2”. The first end plate 110 of the housing 104 defines the second inlet 144. More particularly, the second inlet 144 is disposed at the second longitudinal end 108. Further, the second inlet 144 is disposed proximal to the lower end 116 (see FIG. 2). Further, the second inlet 144 is in fluid communication with the reservoir 130. In another example, the second inlet 144 is in fluid communication with a second reservoir (not shown) that stores the fluid therein. The second inlet 144 receives the second flow of fluid “F2” from the reservoir 130 or the second reservoir.

The battery module 102 also includes the at least one second flow channel 148 in fluid communication with the second inlet 144, extending along the longitudinal direction “A1” of the housing 104, and configured such that a fluid flowing in the at least one second flow channel 148 contacts the plurality of electrochemical cells 122. In the illustrated example, the second flow channel 148 is defined between the bottom surfaces 126 of the electrochemical cells 122 and the lower plate 120 of the housing 104. For exemplary purposes, only a single second flow channel 148 is illustrated herein. However, it should be noted that the battery module 102 may include multiple second flow channels 148 such that each of the multiple second flow channels 148 is in communication with the second inlet 144 and the second outlet 150. In an example, the first flow channel 132 may be substantially parallel to the second flow channel 148. The second flow channel 148 may have any suitable cross-section, such as rectangular, circular, and so forth.

In the illustrated example, the second flow of fluid “F2” flows along the longitudinal direction “A1”. The first flow of fluid “F1” and the second flow of fluid “F2” flow in opposite directions. More particularly, the direction “A2” of the first flow of fluid “F1” is opposite to the direction “A1” of the second flow of fluid “F2”. Providing the first and second flow of fluids “F1”, “F2” in opposite directions provides improved cooling and better temperature distribution across the battery module 102. More particularly, a temperature of the first flow of fluid “F1” is lower proximal to the first longitudinal end 106 whereas the temperature of the first flow of fluid “F1” is higher proximal to the second longitudinal end 108 due to heat exchange with the electrochemical cells 122. Further, a temperature of the second flow of fluid “F2” is lower proximal to the second longitudinal end 108 whereas the temperature of the second flow of fluid “F2” is higher proximal to the first longitudinal end 106 due to heat exchange with the electrochemical cells 122. Thus, the electrochemical cells 122 present proximal to the first and second longitudinal ends 106, 108 may be cooled efficiently by the opposite flow of fluid “F1”, “F2” as compared to cooling provided from a single flow of fluid or from the fluid flowing in the same direction. However, in an alternate embodiment, the first and second flow of fluids “F1”, “F2” may flow in the same direction.

Further, the first flow of fluid “F1” and the second flow of fluid “F2” are controlled independently of each other. More particularly, the first flow of fluid “F1” is controlled by the first valve 136 (shown in FIG. 5) based on control signals received from the control module 138 (shown in FIG. 5) whereas the second flow of fluid “F2” is controlled by a second valve 146 (shown in FIG. 5) based on control signals received from the control module 138. The first and second flow of fluids “F1”, “F2” that flow in opposite directions at different temperatures and flow rates provides improved fluid distribution across the battery module 102 and effective cooling of the electrochemical cells 122.

The second flow channel 148 is disposed proximal to the lower end 116 of the housing 104. Further, the second flow channel 148 is disposed adjacent to the bottom surface 126 of each of the plurality of electrochemical cells 122. The fluid flowing in the second flow channel 148 contacts the plurality of electrochemical cells 122. The second flow channel 148 receives the second flow of fluid “F2” from the second inlet 144. The second flow of fluid “F2” produces a temperature gradient for the electrochemical cells 122 as thermal energy is transferred. More particularly, the fluid flowing through the second flow channel 148 exchanges heat with the electrochemical cells 122 in order to maintain the temperature of the electrochemical cells 122 close to the desired operating temperature.

It should be noted that in some cases it may be desirable to heat the electrochemical cells 122, such as for start-up in low temperature ambient scenarios. In such cases, relative temperatures may be reversed to transfer thermal energy to the electrochemical cells 122 from the second flow of fluid “F2”. Further, the second flow channel 148 may have a small diameter as the fluid that flows through the second flow channel 148 exhibits low viscosity and low surface tension that provides high flow rates inside such channels.

Referring now to FIG. 5, the battery module 102 includes the second valve 146. The second valve 146 controls the second flow of fluid “F2” flowing through the second flow channel 148. In an activated position, the second valve 146 provides fluid communication between the reservoir 130 and the second inlet 144. The second valve 146 may be activated or deactivated based on control signals received from the control module 138 associated with the battery module 102. Further, the battery module 102 includes a second temperature sensor 152 and a second flow rate measuring sensor 154. The second temperature sensor 152 is used to measure a temperature of the second flow of fluid “F2” that flows through the second flow channel 148. Further, the second flow rate measuring sensor 154 is used to measure a flow rate of the second flow of fluid “F2” through the second flow channel 148. In an example, one or more of the busbars 160 may be used for connection lines corresponding to the second temperature sensor 152 and the second flow rate measuring sensor 154 for measuring temperature and flow rate values.

The control module 138 receives signals corresponding to the temperature of the second flow of fluid “F2” and the flow rate of the second flow of fluid “F2”. Further, the control module 138 compares the received signals with corresponding predetermined threshold values corresponding to temperature and flow rate of the second flow of fluid “F2” that may be stored in the memory of the control module 138. Based on the comparison, the control module 138 generates output signals for controlling the temperature of the second flow of fluid “F2” and the flow rate of the second flow of fluid “F2” so that the temperature of the electrochemical cells 122 may be maintained at or adjusted to a desired operating temperature range. For example, the control module 138 may generate an output signal pertaining to an increase or decrease in the temperature of the second flow of fluid “F2”. Accordingly, the second flow of fluid “F2” may be treated such that the temperature of the second flow of fluid “F2” corresponds to the predetermined threshold value for the temperature. In an example, the heat exchanging device positioned downstream of the reservoir 130 may adjust the temperature of the second flow of fluid “F2”. Further, the control module 138 may generate an output signal pertaining to an increase or decrease in the flow rate of the second flow of fluid “F2”. Accordingly, the flow rate of the second flow of fluid “F2” may be adjusted such that the flow rate of the second flow of fluid “F2” corresponds to the predetermined threshold value for the flow rate. In an example, the control module 138 may control the pump, or the second valve 146 may be embodied as a variable flow valve that may be controlled by the control module 138 for adjusting the flow rate of the second flow of fluid “F2”.

As shown in FIG. 4, the battery module 102 further includes the second outlet 150 in fluid communication with the second flow channel 148. As illustrated, the second end plate 112 (see FIG. 2) of the housing 104 defines the second outlet 150. More particularly, the second inlet 144 is disposed at the first longitudinal end 106. Further, the second outlet 150 is disposed proximal to the lower end 116 (see FIG. 2). The second flow channel 148 provides fluid communication between the second inlet 144 and the second outlet 150. Further, the second outlet 150 is in fluid communication with the reservoir 130 such that the second flow of fluid “F2” that exits the battery module 102 via the second outlet 150 is recirculated back to the reservoir 130.

A thermal management arrangement for the battery modules 102 described above may provide improved design flexibility for connection of the plurality of battery modules 102 within the battery system 100. The thermal management arrangement may provide effective contact or immersion cooling of the battery modules 102 using a thermal management fluid, such as a dielectric liquid. The thermal management arrangement may provide efficient cooling of the components of the battery module 102 with lesser amount of fluid. Further, the thermal management arrangement may utilize a low amount of pumping power to circulate the fluid though the battery module 102. Additionally, the battery module 102 described herein may eliminate the requirement of side flow channels that are typically disposed in end plates of battery modules, thereby reducing an overall length of the battery module 102. Elimination of the side flow channels in turn may enable a higher battery energy density. Further, the elimination of the side flow channels may also allow usage of end plates without side flow channels that are available at lower costs.

The fluid used with the battery system 100 and the battery modules 102 may be a thermal management fluid. Suitable thermal management fluids may include or consist essentially of halogenated compounds, oils (e.g., mineral oils, synthetic oils, or silicone oils), or combinations thereof. In some embodiments, the halogenated compounds may include fluorinated compounds, chlorinated compounds, brominated compounds, or combinations thereof. In some embodiments, the halogenated compounds may include or consist essentially of fluorinated compounds. In some embodiments, the thermal management fluids may have an electrical conductivity (at 25 degrees Celsius) of less than about 1e-5 S/cm, less than about 1e-6 S/cm, less than 1e-7 S/cm, or less than about 1e-10 S/cm. In some embodiments, the thermal management fluids may have a dielectric constant that is less than about 25, less than about 15, or less than about 10, as measured in accordance with ASTM D150 at room temperature. In some embodiments, the thermal management fluids may have any one of, any combination of, or all of the following additional properties: sufficiently low melting point (e.g., <−40 degrees C.) and high boiling point (e.g., >80 degrees C. for single phase heat transfer), high thermal conductivity (e.g., >0.05 W/m-K), high specific heat capacity (e.g., >800 J/kg-K), low viscosity (e.g., <2 cSt at room temperature), and non-flammability (e.g., no closed cup flashpoint) or low flammability (e.g., flash point>100 F). In some embodiments, fluorinated compounds having such properties may include or consist of any one or combination of fluoroethers, fluorocarbons, fluoroketones, fluorosulfones, and fluoroolefins. In some embodiments, fluorinated compounds having such properties may include or consist of partially fluorinated compounds, perfluorinated compounds, or a combination thereof.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A battery module comprising:
a housing defining a longitudinal direction along a length of the housing;
a plurality of electrochemical cells received within the housing;
a first inlet configured to receive a first flow of fluid;
at least one first flow channel in fluid communication with the first inlet, extending along the longitudinal direction of the housing, and configured such that a fluid flowing in the at least one first flow channel contacts the plurality of electrochemical cells;
a first outlet in fluid communication with the at least one first flow channel;
a second inlet configured to receive a second flow of fluid;
at least one second flow channel in fluid communication with the second inlet, extending along the longitudinal direction of the housing, and configured such that a fluid flowing in the at least one second flow channel contacts the plurality of electrochemical cells; and
a second outlet in fluid communication with the at least one second flow channel.

2. The battery module of claim 1, wherein the housing defines each of the first inlet, the first outlet, the second inlet, and the second outlet.

3. The battery module of claim 1, wherein the housing further comprises a first longitudinal end and a second longitudinal end opposite to the first longitudinal end, wherein the first inlet and the second outlet are disposed at the first longitudinal end, and wherein the second inlet and the first outlet are disposed at the second longitudinal end.

4. The battery module of claim 1, wherein the housing further comprises an upper end and a lower end opposite to the upper end, wherein the first inlet and the first outlet are disposed proximal to the upper end, and wherein the second inlet and the second outlet are disposed proximal to the lower end.

5. The battery module of claim 4, wherein the at least one first fluid channel is disposed proximal to the upper end of the housing, and wherein the at least one second fluid channel is disposed proximal to the lower end of the housing.

6. The battery module of claim 1, wherein each of the first flow channel and the second flow channel is defined by the housing and the electrochemical cells.

7. The battery module of claim 1, wherein each of the plurality of electrochemical cells comprises a top surface and a bottom surface opposite to the top surface, wherein the at least one first fluid channel is disposed adjacent to the top surface of each of the plurality of electrochemical cells, and wherein the at least one second fluid channel is disposed adjacent to the bottom surface of each of the plurality of electrochemical cells.

8. The battery module of claim 1, wherein the plurality of electrochemical cells are disposed adjacent to each other along the longitudinal direction of the housing.

9. The battery module of claim 1, wherein each of the plurality of electrochemical cells is a prismatic cell.

10. The battery module of claim 1, wherein the first flow of fluid and the second flow of fluid are controlled independently of each other.

11. The battery module of claim 1, wherein a direction of the first flow of fluid flows is opposite to a direction of the second flow of fluid.

12. The battery module of claim 1, wherein the fluid is a cooling liquid.

13. The battery module of claim 1, wherein the fluid comprises a halogenated compound or an oil.

14. The battery module of claim 1, wherein the battery module is at least partially immersed in the fluid.

15. A battery system comprising:
a plurality of battery modules electrically connected to each other, each of the plurality of battery modules comprising:
a housing defining a longitudinal direction along a length of the housing;
a plurality of electrochemical cells received within the housing;
a first inlet configured to receive a first flow of fluid;
at least one first flow channel in fluid communication with the first inlet, extending along the longitudinal direction of the housing, and configured such that a fluid flowing in the at least one first flow channel contacts the plurality of electrochemical cells;
a first outlet in fluid communication with the at least one first flow channel;
a second inlet configured to receive a second flow of fluid;
at least one second flow channel in fluid communication with the second inlet, extending along the longitudinal direction of the housing, and configured such that a fluid flowing in the at least one second flow channel contacts the plurality of electrochemical cells; and
a second outlet in fluid communication with the at least one second flow channel.

16. The battery system of claim 15, wherein the housing defines each of the first inlet, the first outlet, the second inlet, and the second outlet.

17. The battery system of claim 15, wherein the housing further comprises a first longitudinal end and a second longitudinal end opposite to the first longitudinal end, wherein the first inlet and the second outlet are disposed at the first longitudinal end, and wherein the second inlet and the first outlet are disposed at the second longitudinal end.

18. The battery system of claim 15, wherein the housing further comprises an upper end and a lower end opposite to the upper end, wherein the first inlet and the first outlet are disposed proximal to the upper end, and wherein the second inlet and the second outlet are disposed proximal to the lower end.

19. The battery system of claim 18, wherein the at least one first fluid channel is disposed proximal to the upper end of the housing, and wherein the at least one second fluid channel is disposed proximal to the lower end of the housing.

20. The battery system of claim 15, wherein each of the first flow channel and the second flow channel is defined by the housing and the electrochemical cells.
